(19) United States
(12) Patent Application Publication
(10) Pub. No.: US 2019/0191674 A1
(43) Pub. Date: Jun. 27, 2019

(54) Lamp and Fish Tank Combination Assembly

(71) Applicant: Antonio Manuel Rodriguez Perez, Bradenton, FL (US)

(72) Inventor: Antonio Manuel Rodriguez Perez, Bradenton, FL (US)

(21) Appl. No.: 15/850,979

(22) Filed: Dec. 21, 2017

(51) Int. Cl. A01K 63/06; A01K 63/00; F21S 6/00

(52) U.S. Cl. CPC A01K 63/06; F21W 2131/308; F21S 6/002; A01K 63/003

(57) ABSTRACT

A lamp and fish tank combination assembly for emitting light downwardly towards the aquarium and outwardly from a light source includes a tank that is filled with water and houses fish. A lighting unit is positioned on top of the tank. The lighting unit emits light downwardly into the tank and laterally from the lighting unit when the lighting unit is turned on.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to illuminated aquarium devices and more particularly pertains to a new illuminated aquarium device for emitting light downwardly towards the aquarium and outwardly from a light source.

### BRIEF SUMMARY OF THE INVENTION

An embodiment of the disclosure meets the needs presented above by generally comprising a tank that is configured to be filled with water and house fish. A lighting unit is positioned on top of the tank. The lighting unit emits light downwardly into the tank and laterally from the lighting unit when the lighting unit is turned on.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front view of a lamp and fish tank combination assembly according to an embodiment of the disclosure.

FIG. 2 is an exploded view of components of an embodiment of the disclosure.

FIG. 3 is a bottom view of an embodiment of the disclosure.

FIG. 4 is a front view of an embodiment of the disclosure.

FIG. 5 is a cross-sectional view of an embodiment of the disclosure taken along line 5-5 of FIG. 4.

### DETAILED DESCRIPTION OF THE INVENTION

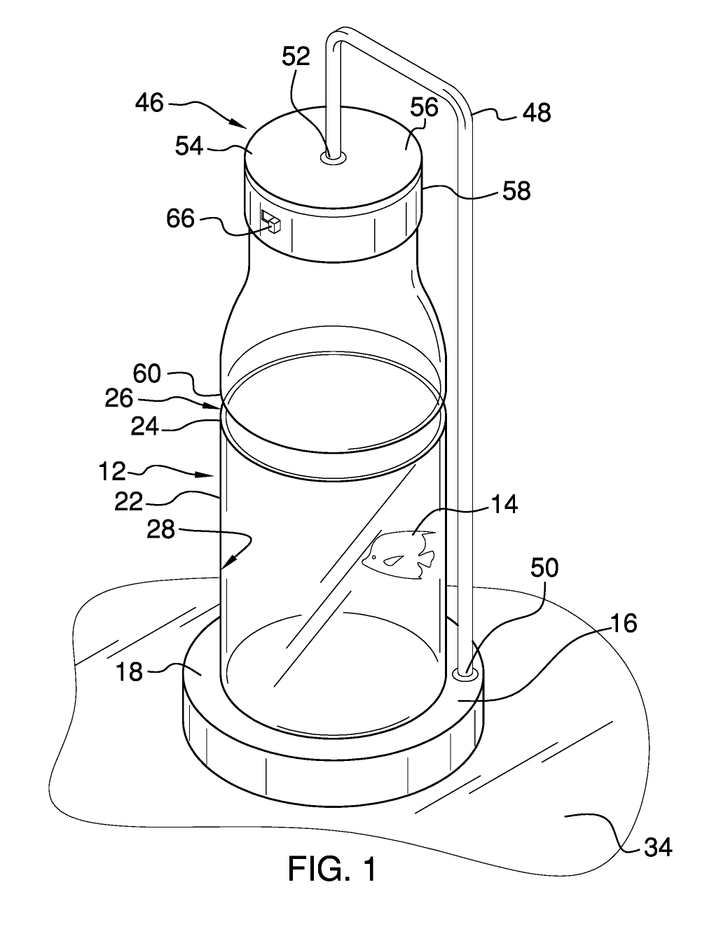

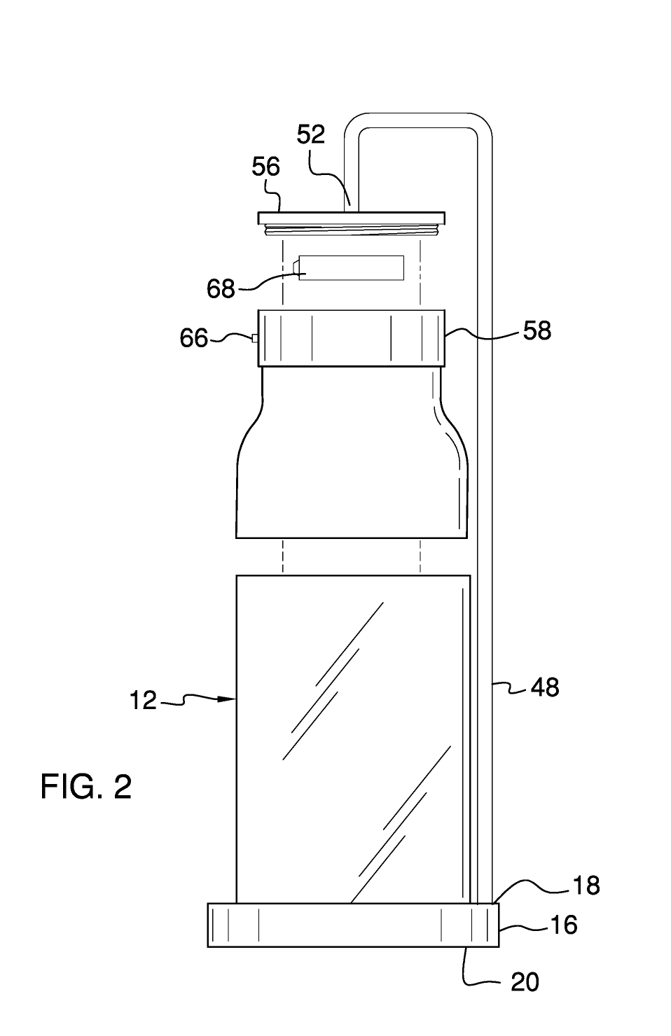

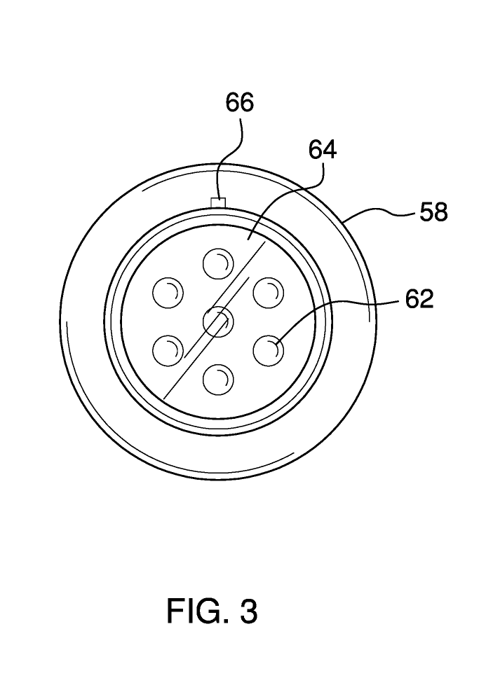

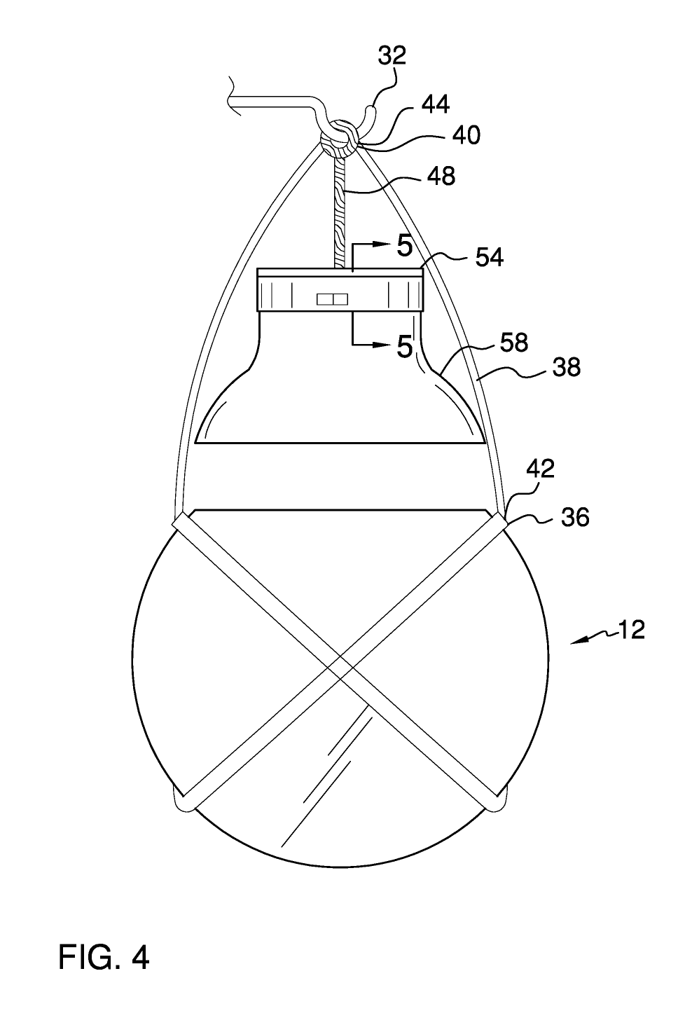

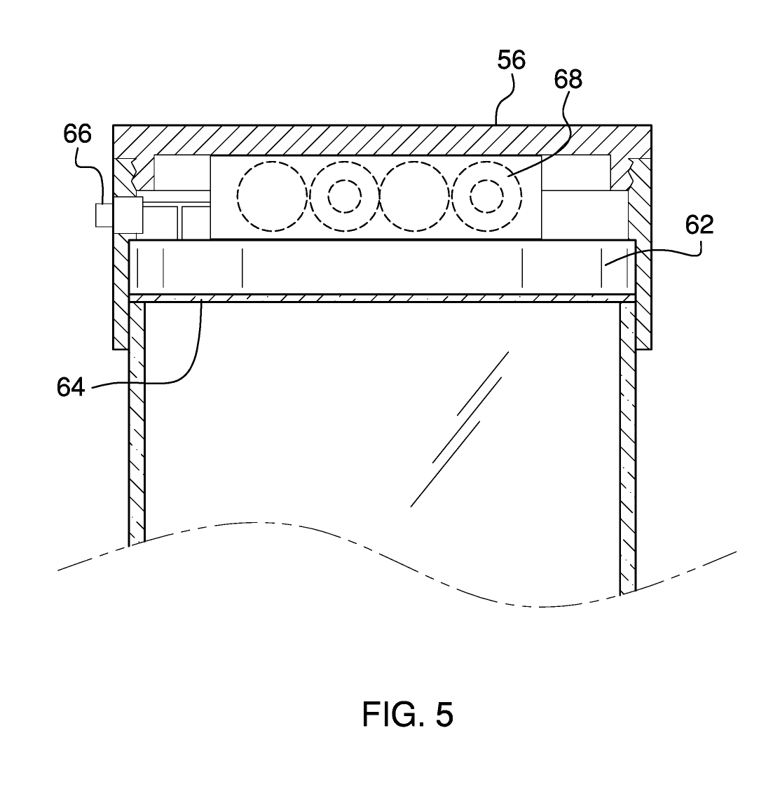

With reference now to the drawings, and in particular to FIGS. 1 through 5 thereof, a new illuminated aquarium device embodying the principles and concepts of an embodiment of the disclosure and generally designated by the reference numeral 10 will be described.

As best illustrated in FIGS. 1 through 5, the lamp and fish tank combination assembly 10 generally comprises a tank 12 that is filled with water and houses fish 14. The tank 12 includes a base 16 that has a top side 18 and a bottom side 20. A perimeter wall 22 is attached to and extends upwardly from the base 16. The perimeter wall 22 comprises a transparent material and has an upper edge 24 that forms an opening 26 that extends into an interior 28 bounded by the perimeter wall 22. The perimeter wall 22 may have a cylindrical shape but may have another shape.

A lighting unit 30 is positioned on top of the tank 12. The lighting unit 30 emits light downwardly into the tank 12 and laterally from the lighting unit 30 when the lighting unit 30 is turned on. The term “laterally” here means above and outside of the tank 12 such that the lighting unit lights an area round the tank 12 so that it may be used to illuminate a room containing the tank 12. The lighting unit 30 comprises a housing 32 that includes an upper wall 34 and a peripheral wall 36 that is attached to and extends downwardly from the upper wall 34. The peripheral wall 36 is translucent. The upper wall 34 is removable from the peripheral wall 36.

A plurality of light emitters 38 is mounted in the housing 32. Each of the light emitters 38 emits light downwardly into the tank 12 and outwardly through the peripheral wall 36 when the light emitters 38 are turned on. Each of the light emitters 38 comprises a light emitting diode. A window 40 is attached to the peripheral wall 36 and covers the light emitters 38 such that the light emitters 38 are positioned between the window 40 and the upper wall 34. The window 40 may comprise of a lens such that the window 40 may reflect light outwardly from the housing 32 at different angles as well as change a color of the light emitted.

A power switch 42 is electrically coupled to each of the light emitters 38 and is actuated to turn the light emitters 38 on. The power switch 42 is mounted on the peripheral wall 36. A power supply 44 is electrically coupled to the light emitters 38. The power supply 44 is positioned within the housing 32 and is accessible when the upper wall 34 is removed from the peripheral wall 36. The power supply 44 comprises at least one battery.

In use, the assembly 10 is used conventionally as a light source. The tank 12 is positioned upright with the base 16 on a ground surface 46. The power switch 42 is actuated to illuminate each of the light emitters 38. Each of the light emitters 38 emits light downwardly toward the tank 12 and outwardly from the peripheral wall 36 such that the light emitters 38 act as a conventional light source.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lamp and aquarium combination assembly comprising:
a tank configured to be filled with water and house fish; and
a lighting unit being positioned on top of said tank, said lighting unit emitting light downwardly into said tank and laterally from said lighting unit when said lighting unit is turned on.

2. The lamp and aquarium combination assembly according to claim 1, wherein said tank includes:
a base having a top side and a bottom side; and
a perimeter wall being attached to and extending upwardly from said base, said perimeter wall being comprised of a transparent material and having an upper edge forming an opening extending into an interior bounded by said perimeter wall.

3. The lamp and aquarium combination assembly according to claim 2, wherein said perimeter wall has a cylindrical shape.

4. The lamp and aquarium combination assembly according to claim 1, wherein said lighting unit comprises:
a housing including an upper wall and a peripheral wall being attached to and extending downwardly from said upper wall, said peripheral wall being translucent, said upper wall being removable from said peripheral wall;
a plurality of light emitters being mounted in said housing, each of said light emitters emitting light downwardly into said tank and outwardly through said peripheral wall when said light emitters are turned on, each of said light emitters comprising a light emitting diode;
a window being attached to said peripheral wall and covering said light emitters such that said light emitters are positioned between said window and said upper wall;
a power switch being electrically coupled to each of said light emitters and being actuated to turn said light emitters on, said power switch being mounted on said peripheral wall; and
a power supply being electrically coupled to said light emitters, said power supply being positioned within said housing, said power supply comprising at least one battery, said power supply being accessible when said upper wall is removed from said peripheral wall.

5. A lamp and aquarium combination assembly comprising:
a tank configured to be filled with water and house fish, said tank including:
a base having a top side and a bottom side;
a perimeter wall being attached to and extending upwardly from said base, said perimeter wall being comprised of a transparent material and having an upper edge forming an opening extending into an interior bounded by said perimeter wall, said perimeter wall having a cylindrical shape;
a lighting unit being positioned on top of said tank, said lighting unit emitting light downwardly into said tank and laterally from said lighting unit when said lighting unit is turned on, said lighting unit comprising:
a housing including an upper wall and a peripheral wall being attached to and extending downwardly from said upper wall, said peripheral wall being translucent, said upper wall being removable from said peripheral wall;
a plurality of light emitters being mounted in said housing, each of said light emitters emitting light downwardly into said tank and outwardly through said peripheral wall when said light emitters are turned on, each of said light emitters comprising a light emitting diode;
a window being attached to said peripheral wall and covering said light emitters such that said light emitters are positioned between said window and said upper wall;
a power switch being electrically coupled to each of said light emitters and being actuated to turn each of said light emitters on, said power switch being mounted on said peripheral wall; and
a power supply being electrically coupled to said light emitters, said power supply being positioned within said housing, said power supply comprising at least one battery, said power supply being accessible when said upper wall is removed from said peripheral wall.
